(19) United States
(12) Patent Application Publication
(10) Pub. No.: US 2026/0249282 A1
(43) Pub. Date: Aug. 27, 2026

(54) ANION EXCHANGE POLYMER COMPRISING 4-X-QUINUCLIDINIUM STRUCTURE, METHOD FOR PREPARING SAME, AND ANION EXCHANGE MEMBRANE COMPRISING SAME

(71) Applicant: HD HYUNDAI OILBANK CO., LTD., Seosan-si (KR)

(72) Inventors: Seung Young CHOI, Yongin-si (KR); Na Young KIM, Yongin-si (KR); Minjin LEE, Yongin-si (KR); Seungwon HAN, Yongin-si (KR); Yeon Ho AHN, Yongin-si (KR); Min Sang CHO, Yongin-si (KR); Tae Eun KIM, Yongin-si (KR)

(21) Appl. No.: 19/647,023

(22) Filed: Apr. 14, 2026

Related U.S. Application Data
(63) Continuation of application No. PCT/KR2024/017060, filed on Nov. 1, 2024.

(30) Foreign Application Priority Data
Aug. 19, 2024 (KR) 10-2024-0110663

(51) Int. Cl. B01J 41/09; C08F 12/32; C25B 9/23; C25B 13/08

(52) U.S. Cl. CPC B01J 41/09; C08F 12/32; C25B 9/23; C25B 13/08

(57) ABSTRACT

An anion exchange polymer according to a preferred embodiment of the present invention includes a 4-X-quinuclidinium structure in which carbon corresponding to position 4 of a quinuclidinium ring is connected to a polymer main chain (X), and due to the absence of β-hydrogen placed in an anti-periplanar conformation with a nitrogen atom in the quinuclidinium ring, a Hoffmann elimination reaction does not occur. Therefore, there is the effect of having a chemically stable structure in a basic driving environment.

### CROSS-REFERENCE TO RELATED APPLICATION

This application is a continuation of pending PCT International Application No. PCT/KR2024/017060, filed on Nov. 1, 2024, which claims priority to Korean Patent Application No. 10-2024-0110663 filed on Aug. 19, 2024, the entire contents of which are hereby incorporated by references in its entirety.

### TECHNICAL FIELD

The present invention relates to an anion exchange membrane (AEM), and more specifically, to an AEM including an anion exchange polymer including a 4-X-quinuclidinium structure having excellent alkali stability, and a method of preparing the same.

### BACKGROUND ART

Anion exchange membranes (AEMs) are polymer membranes that serve as electrolytes and play a role in selectively transporting anions (primarily OH⁻, Cl⁻, Br⁻, etc.) in electrochemical systems. These membranes function to move anions within a positively charged polymer structure and are utilized in various energy conversion devices, such as AEM fuel cells (AEMFCs), AEM water electrolysis (AEMWE) systems, redox flow batteries (RFBs), and reverse electrodialysis (RED) systems, to perform the role of selectively transporting anions. In these energy devices, the performance of AEMs is largely determined by conductivity and stability, and for this, stability under basic conditions is essential.

Recently, efforts have been actively made to develop polymers including cationic functional groups with structures that are chemically stable in alkaline environments. In research conducted to date, cationic functional groups such as piperidinium, imidazolium, and trimethylammonium (TMA) have been used as cationic functional groups for AEM applications. However, these structures may be chemically degraded by attack from OH-anions, particularly when exposed to basic environments, and this chemical instability may be a limiting factor for the long-term performance of fuel cell and water electrolysis systems.

### DETAILED DESCRIPTION OF THE INVENTION

### Technical Problem

The present invention was conceived to solve the above-described problems and provides an anion exchange polymer which has a chemically stable structure in a basic operating environment, and, in particular, is resistant to Hofmann elimination reactions because β-hydrogen does not form an anti-periplanar conformation, thus exhibiting excellent alkali stability, and a method of preparing the same.

The technical problems of the present invention are not limited to the above-mentioned technical problems, and other technical problems that are not mentioned will be clearly understood by a person skilled in the art from the description below.

### Technical Solution

In order to address the above-described technical problems, an anion exchange polymer according to a preferred example of the present invention may include: a 4-X-quinuclidinium structure represented by Chemical Formula 1 below, wherein carbon corresponding to position 4 of a quinuclidinium ring is connected to a polymer main chain (X):

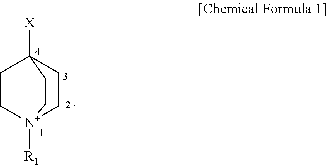

In Chemical Formula 1, X includes a repeating unit represented by Chemical Formula 2 below or an arylene compound, and R₁ is hydrogen, a C1-C20 alkyl group, a C1-C20 aryl group, or a derivative thereof:

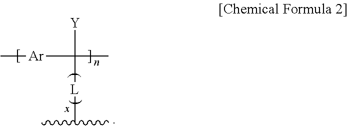

In Chemical Formula 2, Ar includes an arylene compound, Y includes hydrogen, a methyl group (—CH₃), an ethyl group (—C₂H₅), a methoxy group (—OCH₃), an ethoxy group (—OC₂H₅), a phenyl group (—C₆H₅), a benzyl group (—CH₂C₆H₅), a trifluoromethyl group (—CF₃), a trifluoromethoxy group (—OCF₃), a hexafluoroethoxy group (—OC₂F₆), or a derivative thereof, L includes a C1-C10 alkyl group, a C1-C10 aryl group, a derivative thereof or a combination thereof, n is an integer greater than or equal to 1, and x is an integer greater than or equal to 0.

In addition, in Chemical Formula 2, the X of Chemical Formula 1 may be connected to the position indicated by a wavy line.

The anion exchange polymer may include a repeating unit represented by Chemical Formula 3 below:

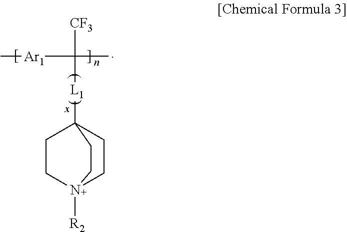

In Chemical Formula 3, Ar₁ includes an arylene compound, L₁ includes a C1-C10 alkyl group, a C1-C10 aryl group, a derivative thereof, or a combination thereof, R₂ is hydrogen, a C1-C10 alkyl group, a C1-C10 alkoxy group, a C1-C10 aryl group, or a derivative thereof, n is an integer greater than or equal to 1, and x is an integer greater than or equal to 0.

The anion exchange polymer may include a repeating unit represented by Chemical Formula 4 below:

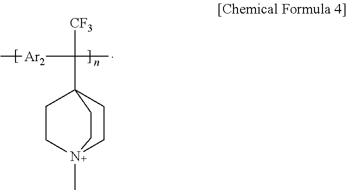

In Chemical Formula 4, Ar₂ includes an arylene compound, and n is an integer greater than or equal to 1.

The anion exchange polymer may include a poly (arylene-4-(N-methyl-quinuclidinium) trifluoromethyl) repeating structure.

The anion exchange polymer may include β-hydrogen that does not form an anti-periplanar conformation inside the quinuclidinium cage.

In order to address the above-described technical problems, an anion exchange membrane (AEM) according to a preferred example of the present invention may include the anion exchange polymer.

In order to address the above-described technical problems, a membrane-electrode assembly according to a preferred example of the present invention may include the anion exchange polymer.

In order to address the above-described technical problems, a water electrolysis system according to a preferred example of the present invention may include the anion exchange polymer.

In order to address the above-described technical problems, a method of preparing an anion exchange polymer according to a preferred example of the present invention may include: a step S01 of synthesizing a quinuclidine monomer by allowing a quinuclidine precursor, an organic acid, a catalyst, and a solvent to react; a step S02 of synthesizing a poly (arylene quinuclidine) polymer by polycondensation reaction using the quinuclidine monomer, an arylene compound, and a superacid catalyst after Step S01; and a step S03 of synthesizing a poly (arylene quinuclidinium) polymer by forming a quaternary ammonium salt via a Menshutkin reaction using the quinuclidine polymer and an alkyl halide after Step S02.

### Advantageous Effects

According to the present invention described above, the anion exchange polymer according to a preferred embodiment of the present invention has the effect of having a chemically stable structure in a basic operating environment, as β-hydrogen does not form an anti-periplanar conformation and is resistant to Hofmann elimination reactions.

The effects of the present invention are not limited to above-mentioned effects, and include other effects that are clearly understood by a person skilled in the art from the description throughout the specification but are not explicitly mentioned.

### DESCRIPTION OF THE DRAWINGS

FIG. 1 shows three-dimensional stereochemical structures of a quinuclidinium structure and a piperidinium structure according to one embodiment of the present invention (Source: L. Yin et al., Angew. Chem. Int. Ed., 63, e202400764-e202400773, 2024).

FIG. 2 shows chemical structures illustrating the bonding positions of β-hydrogen (indicated by red arrows) in the structures of 1-X-quinuclidinium (1-X-qui) and 4-X-quinuclidinium (4-X-qui) according to one embodiment of the present invention.

FIG. 3 shows a flowchart illustrating the synthesis steps of an anion exchange polymer including a 4-X-quinuclidinium structure according to one embodiment of the present invention.

### BEST MODE

Hereinafter, preferred embodiments of the present invention will be described in detail with reference to the accompanying drawings. The advantages and features of the present invention and methods for achieving them will become apparent with reference to the embodiments described in detail below together with the accompanying drawings. However, the present invention is not limited to the embodiments disclosed below, but may be implemented in various different forms, and the present embodiments are provided only to make the disclosure of the present invention complete and to fully inform those skilled in the art of the scope of the invention, and the present invention is defined only by the scope of the claims. The same reference numerals refer to the same elements throughout the specification.

Unless otherwise defined, all terms (including technical and scientific terms) used herein may be used as the same meaning as generally understood by one of ordinary skill in the art to which the present invention pertains. In addition, terms defined in commonly used dictionaries are not interpreted in an idealized or overly formal sense unless clearly so defined in the present invention. The terminology used herein is for the purpose of describing embodiments only and is not intended to limit the present invention. Singular forms used herein include plural forms, unless the context clearly indicates otherwise.

“Comprise” and/or “comprising” used herein specify (ies) the presence of mentioned components, steps, operations, and/or devices do(es) not preclude the possibility of the presence or addition of one or more other components, steps, operations, and/or devices.

### Anion Exchange Polymer Including a 4-X-Quinuclidinium Structure

An anion exchange polymer according to one embodiment of the present invention may include a 4-X-quinuclidinium structure in which position 4 of a quinuclidinium ring is connected to a polymer main chain (X).

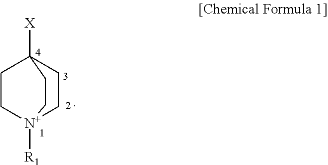

In Chemical Formula 1, X includes a repeating unit represented by Chemical Formula 2 below or an arylene compound, and R₁ is hydrogen, a C1-C20 alkyl group, a C1-C20 aryl group, or a derivative thereof:

In this case, the anion may be a hydroxide ion (OH), and the notation may be omitted.

In Chemical Formula 1, quinuclidinium may be a compound having a bicyclic structure as a cationic form of quinuclidine. This structure may include a nitrogen (N) atom shared by two rings and may have a 1-azabicyclo [2.2.2] octane (ABCO) framework. In this quinuclidinium structure, the nitrogen atom is positively charged through quaternization and may include various substituents (R₁) that bond to the nitrogen atom site.

The quinuclidinium may be included as a polymeric side chain, and in particular, carbon corresponding to position 4 of a quinuclidinium ring may be connected to a polymeric main chain (X). In this case, the carbon corresponding to position 4 of the quinuclidinium ring may refer to a third carbon atom from the nitrogen (N) atom. Specifically, nitrogen (N) corresponds to position 1 of the quinuclidinium ring, and a carbon connected therefrom may be the carbon corresponding to position 4 of the quinuclidinium ring.

The carbon at position 4 of the quinuclidinium ring may form a tetrahedral framework reflecting sp³ hybridization. In addition, the carbon at position 4 may maintain a bond angle of 109.5 degrees and may possess high symmetry through a bicyclic structure. These structural characteristics result in an overall balanced chemical structure, which can alleviate physical stress and minimize distortion that may occur during polymer formation. Consequently, the carbon at position 4 of the quinuclidinium ring can provide chemical stability and structural rigidity.

In particular, when a quinuclidine ring is included as a polymer side chain within a polymer structure, the quinuclidine ring has a bicyclic cage structure, which increases structural rigidity and reduces distortion, thereby exhibiting an effect of increasing the chemical stability of the polymer. Furthermore, the quinuclidine structure within the polymer structure can be less susceptible to Hofmann elimination reactions and relatively stable because β-hydrogen does not form an anti-periplanar conformation. On the other hand, the piperidinium structure may be decomposed in a basic environment in which β-hydrogen is easily eliminated, thus having relatively lower chemical stability compared to the quinuclidine structure.

The X may include a repeating unit represented by Chemical Formula 2 below or an arylene compound.

Specifically, the X may include a repeating unit represented by Chemical Formula 2 below:

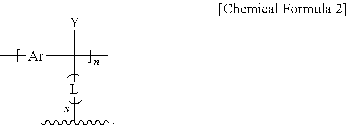

In Chemical Formula 2, Ar includes an arylene compound, Y includes hydrogen, a methyl group (—CH₃), an ethyl group (—C₂H₅), a methoxy group (—OCH₃), an ethoxy group (—OC₂H₅), a phenyl group (—C₆H₅), a benzyl group (—CH₂C₆H₅), a trifluoromethyl group (—CF₃), a trifluoromethoxy group (—OCF₃), a hexafluoroethoxy group (—OC₂F₆), or a derivative thereof, L includes a C1-C10 alkyl group, a C1-C10 aryl group, a derivative thereof or a combination thereof, n is an integer greater than or equal to 1, and x is an integer greater than or equal to 0.

In addition, in Chemical Formula 2, the X of Chemical Formula 1 may be connected to the position indicated by a wavy line.

The L is a spacer included in the polymer side chain and may include a C1-C10 alkyl group, a C1-C10 aryl group, a derivative thereof, or a combination thereof. Specifically, the L may include a methyl group, an ethyl group, a propyl group, a butyl group, a pentyl group, a hexyl group, a heptyl group, an octyl group, a nonyl group, a decyl group, a methoxy group, an ethoxy group, a phenyl group, a benzyl group, a phenylethyl group, a phenylpropyl group, a phenyloxy group, methoxybenzene, biphenyl, triphenyl, tetraphenyl, a derivative thereof, or a combination thereof.

Specifically, the Y may include hydrogen, a methyl group (—CH₃), an ethyl group (—C₂H₅), a methoxy group (—OCH₃), an ethoxy group (—OC₂H₅), a phenyl group (—C₆H₅), a benzyl group (—CH₂C₆H₅), a trifluoromethyl group (—CF₃), a trifluoromethoxy group (—OCF₃), a hexafluoroethoxy group (—OC₂F₆), or a derivative thereof, and in one embodiment, the Y may include a trifluoromethyl group (—CF₃), but is not limited thereto. When the Y includes a trifluoromethyl group (—CF₃), the synthesized polymer may be imparted properties such as hydrophobicity, an electron-withdrawing effect, enhanced thermal stability, and chemical resistance.

The spacer (L) serves to prevent distortion of the quinuclidinium cage. In particular, when the quinuclidinium structure is directly bonded to two phenyl groups included in the polymer main chain, structural instability of the quinuclidinium ring may be induced. Therefore, when an appropriate spacer (L) is used, such structural distortion can be mitigated, and the chemical durability of the anion exchange polymer can be improved. The spacer (L) secures space between the quinuclidinium cage structure and the phenyl groups to relieve structural stress and maintain flexible bonding within the polymer.

In addition, the spacer (L) has the characteristic of facilitating phase separation in which the hydrophobic polymer main chain (X) and the hydrophilic polymer side chain (4-X-quinuclidinium structure) moieties are physically separated and arranged within the anion exchange polymer, and the phases are distinguished and separated from each other. Through this, the hydrophilic groups (4-X-quinuclidinium structure) can gather to effectively form anion transport channels within the anion exchange polymer, thereby improving ion conductivity.

The arylene compound (Ar) is a polymeric compound in which aromatic rings, such as aryl groups or arylene units, are repeatedly connected. Each arylene unit is generally derived from a benzene ring (C₆H₆) or other aromatic compounds, and these units may be connected to each other through carbon-carbon (C—C), ether (O), or amine (N) bonds, and the like. For example, the arylene compound may include polymeric structures formed by connecting aryl groups through carbon-carbon bonds, ether bonds (—O-), or amine bonds (—NH-), such as polyphenylene (PP), polyphenylene ether (PPE), and polyphenylene amine. An arylene structure in which a plurality of aromatic rings are connected can exhibit high thermal stability, high mechanical strength, and excellent chemical resistance.

Specifically, the arylene compound (Ar) may include any one selected from compounds represented by the following structural formula or a derivative thereof;

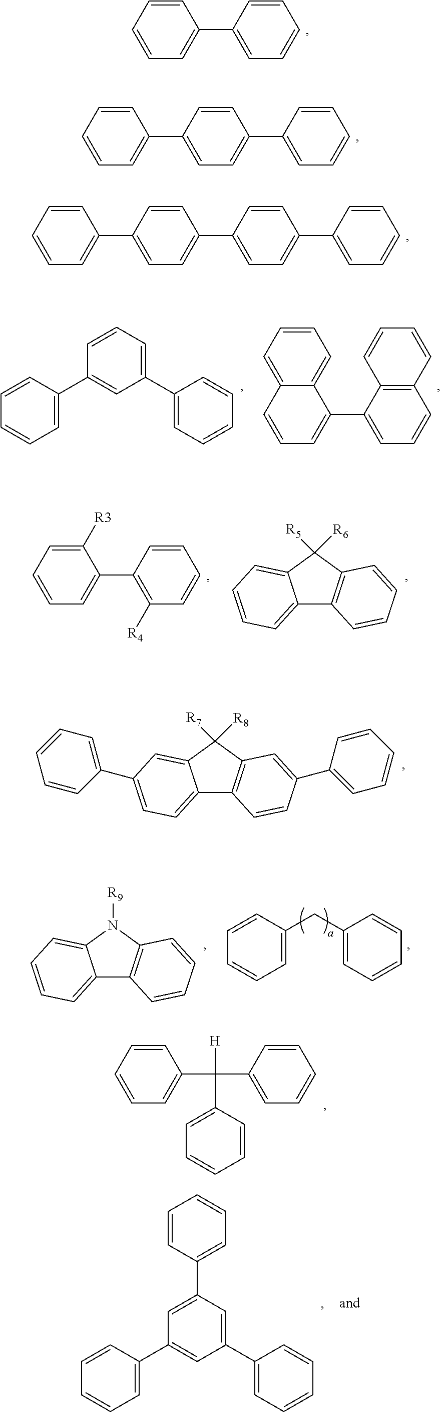

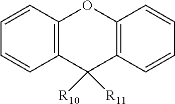

Here, R₃ to R₁₁ may each independently include hydrogen, a C1-C10 alkyl group, a C1-C10 aryl group, or a derivative thereof, and a may be an integer greater than or equal to 1.

Meanwhile, the X may not be an arylene compound (Ar) included in the repeating unit represented by Chemical Formula 2, but may be an arylene compound itself or an arylene compound in which a spacer (L) is connected to a moiety of the chemical structure. In this case, the 4-X-quinuclidinium structure of Chemical Formula 1 may be included at position R of the arylene compound, for example, at positions R₃ to R₁₁, or the 4-X-quinuclidinium structure of Chemical Formula 1 may be included to be connected to a spacer (L) connected to a moiety of the chemical structure of the arylene compound.

Specifically, the anion exchange polymer may include a repeating unit represented by Chemical Formula 3 below. More specifically, the anion exchange polymer may include a poly (arylene-4-(N-methyl-quinuclidinium) trifluoromethyl) structure:

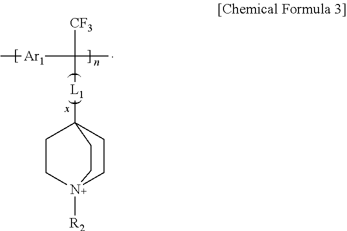

In Chemical Formula 3, Ar₁ includes an arylene compound, L₁ includes a C1-C10 alkyl group, a C1-C10 aryl group, a derivative thereof, or a combination thereof, R₂ is hydrogen, a C1-C10 alkyl group, a C1-C10 alkoxy group, a C1-C10 aryl group, or a derivative thereof, n is an integer greater than or equal to 1, and x is an integer greater than or equal to 0.

More specifically, the anion exchange polymer may include a repeating unit represented by Chemical Formula 4 below. The anion exchange polymer may include poly (arylene-4-(N-methyl-quinuclidinium)) trifluoromethyl as a repeating unit:

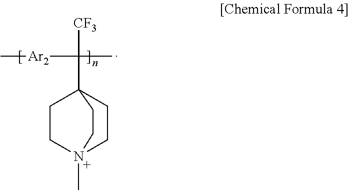

In Chemical Formula 4, Ar2 includes an arylene compound, and n is an integer greater than or equal to 1.

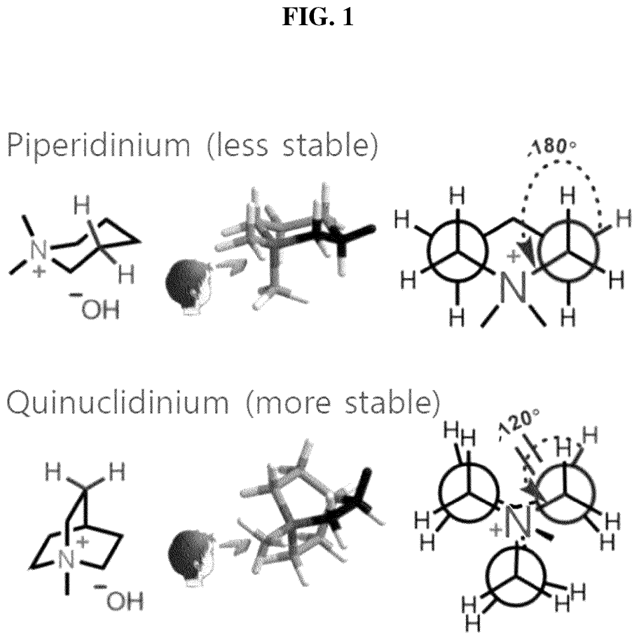

FIG. 1 shows three-dimensional stereochemical structures of a quinuclidinium structure and a piperidinium structure according to one embodiment of the present invention (Source: L. Yin et al., Angew. Chem. Int. Ed., 63, e202400764-e202400773, 2024).

Piperidinium has a six-membered cyclic structure lacking double bonds, and this piperidinium-based structure undergoes continuous flipping between boat-chair conformations in the chemical structure. During this process, when the chair structure is formed, the nitrogen atom is positioned in an anti-periplanar conformation with the axially positioned β-hydrogen, which may lead to Hofmann elimination (E2 elimination) reactions. Consequently, the piperidinium ring is easily decomposed in a basic environment, resulting in reduced chemical stability. In contrast, quinuclidine-based structures do not have a boat-chair conformation, and due to their unique bicyclic cage structure, there is no β-hydrogen positioned in an anti-periplanar conformation. Due to these structural characteristics, quinuclidine-based structures are resistant to Hofmann elimination reactions and exhibit higher chemical stability in a basic environment.

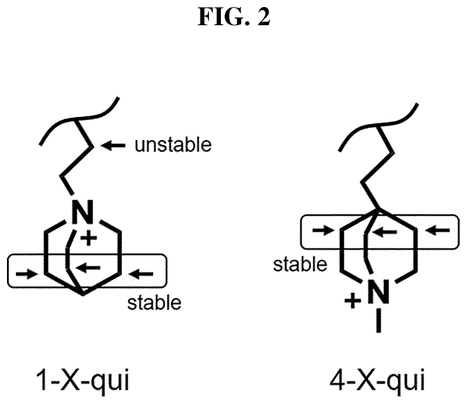

FIG. 2 shows chemical structures illustrating the bonding positions of β-hydrogen (indicated by red arrows) in the structures of 1-X-quinuclidinium (1-X-qui) and 4-X-quinuclidinium (4-X-qui) according to one embodiment of the present invention.

Referring to FIG. 2, it can be seen that in the case of the 1-X-qui structure, the N atom is directly connected to an alkyl chain, so β-hydrogens are present outside the quinuclidinium cage, whereas in the case of the 4-X-qui structure, β-hydrogens are present only inside the quinuclidinium cage. Specifically, in the 1-X-qui structure, six β-hydrogens (hydrogens bonded to the carbon labeled as stable in the 1-X-qui structure) are present inside the quinuclidinium cage, and two additional β-hydrogens (hydrogens bonded to the carbon labeled as unstable in the 1-X-qui structure) are present in the alkyl chain outside the quinuclidinium cage. Here, the β-hydrogens inside the quinuclidinium cage do not form an anti-periplanar conformation and are relatively stable, but the β-hydrogens positioned outside are in vulnerable positions that may be easily attacked by OH ions. As a result, the 1-X-qui structure is likely to decompose in a basic environment.

In contrast, the 4-X-qui structure has a structure that can compensate for this vulnerability. Because the 4-X-qui structure does not have β-hydrogens outside the quinuclidinium cage, the 4-X-qui structure has higher resistance to Hofmann elimination reactions. In the 4-X-qui structure, all β-hydrogens are present only inside the quinuclidinium cage (hydrogens bonded to carbons labeled as stable in the 4-X-qui structure), and since they do not form an anti-periplanar conformation, they are stable even in a basic environment. Therefore, the 4-X-qui structure provides much better stability in a basic environment compared to the 1-X-qui structure and can serve as a more suitable structure for various applications requiring high-temperature and basic conditions.

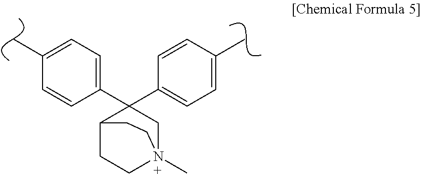

Meanwhile, since a 3-X-quinuclidinium (3-X-qui) structure (Chemical Formula 5) is not a left-right symmetrical structure, when a bulky group is present nearby, the bond angle may easily be distorted. When the bond angle is distorted, the excellent alkali stability inherent to the quinuclidinium ring may be reduced, which lowers the chemical resistance and durability of the polymer and, eventually, significantly degrades the performance of the polymer in an alkaline environment. In contrast, the 4-X-quinuclidinium (4-X-qui) structure is a left-right symmetrical structure, which can minimize structural distortion of the polymer and improve structural stability and ion conductivity.

### Method of Preparing an Anion Exchange Polymer Including a 4-X-Quinuclidinium Structure

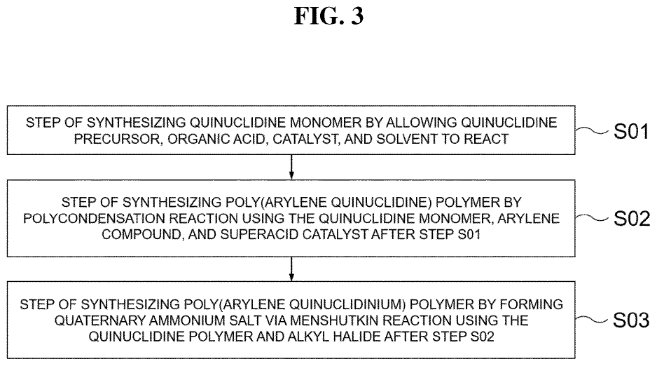

FIG. 3 and Reaction Schemes 1 to 3 below are a flowchart and reaction schemes illustrating the synthesis steps of an anion exchange polymer including a 4-X-quinuclidinium structure according to one embodiment of the present invention.

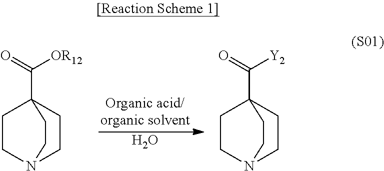

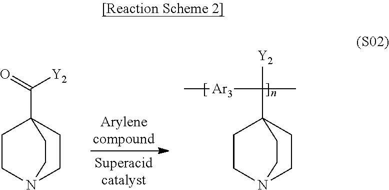

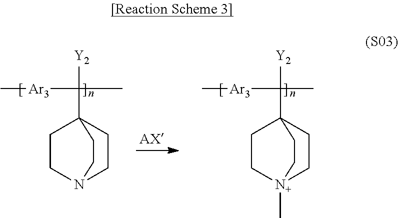

In Reaction Schemes 1 to 3, Ar₃ includes an arylene compound, R₁₂ is hydrogen, a C1-C20alkyl group, a C1-C20 aryl group or a derivative thereof, Y₂ includes hydrogen, a methyl group (—CH₃), an ethyl group (—C₂H₅), a methoxy group (—OCH₃), an ethoxy group (—OC₂H₅), a phenyl group (—C₆H₅), a benzyl group (—CH₂C₆H₅), a trifluoromethyl group (—CF₃), a trifluoromethoxy group (—OCF₃), a hexafluoroethoxy group (—OC₂F₆), or a derivative thereof, A is a C1-C3 alkyl group, n is an integer greater than or equal to 1, and X′ is a halogen element.

Referring to FIG. 3 and Reaction Schemes 1 to 3, a step (S01) of synthesizing a quinuclidine monomer by allowing a quinuclidine precursor, an organic acid, a catalyst, and a solvent to react may first be carried out.

The quinuclidine precursor may include a quinuclidine compound including a carboxylic moiety. Specifically, the quinuclidine precursor may be a compound including a carboxylic moiety at a carbon corresponding to position 4 of a quinuclidine dual ring.

Specifically, the quinuclidine precursor may include a compound represented by Chemical Formula 6 below, a salt thereof, or a hydrate thereof:

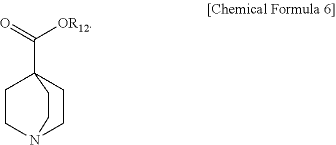

In Chemical Formula 6, R₁₂ is hydrogen, a C1-C20 alkyl group, a C1-C20 aryl group, or a derivative thereof.

In one embodiment, the quinuclidine precursor may include quinuclidine-4-carboxylic acid, but is not limited thereto.

In addition, the organic acid may react with an OH group of the carboxylic moiety of the quinuclidine precursor to introduce an acyl group (—COR). Specifically, the organic acid may include a non-fluorinated organic acid, a fluorinated organic acid, an anhydride thereof, or a combination thereof. For example, the organic acid may include: a non-fluorinated organic acid including acetic anhydride, propionic anhydride, butyric anhydride, benzoic anhydride, and maleic anhydride; a fluorinated organic acid including trifluoroacetic anhydride (TFAA), pentafluoropropionic anhydride, and pentafluorobenzoic anhydride; or combinations thereof. More specifically, the organic acid may be a fluorinated organic acid, and in one embodiment, the organic acid may include TFAA, but is not limited thereto.

The catalyst may be used as a catalyst and an organic solvent in the reaction of Reaction Scheme 1, and may include, for example, any one selected from pyridine, 4-dimethylaminopyridine (DMAP), triethylamine (TEA), N,N-dimethylaniline, triisopropylamine (TIPA), and combinations thereof. In one embodiment, the catalyst may include pyridine, but is not limited thereto.

The solvent may be a polar solvent and may include, for example, any one selected from water, acetone, dimethylformamide (DMF), dichloromethane (DCM), tetrahydrofuran (THF), methanol, ethanol, ethyl acetate, and combinations thereof. In one embodiment, the solvent may include water, but is not limited thereto.

The catalyst and the solvent may induce or promote hydrolysis and decarboxylation reactions of the reactants.

Next, a step (S02) of synthesizing a poly (arylene quinuclidine) polymer by

polycondensation reaction using the quinuclidine monomer, an arylene compound, and a superacid catalyst may be carried out.

The synthesized quinuclidine monomer may include a compound represented by Chemical Formula 7 below, a salt thereof, or a hydrate thereof:

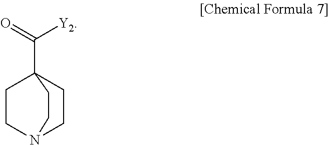

In Chemical Formula 7, Y₂ may include hydrogen, a methyl group (—CH₃), an ethyl group (—C₂H₅), a methoxy group (—OCH₃), an ethoxy group (—OCH₅), a phenyl group (—C₆H₅), a benzyl group (—CH₂C₆H₅), a trifluoromethyl group (—CF₃), a trifluoromethoxy group (—OCF₃), a hexafluoroethoxy group (—OC₂F₆), or a derivative thereof.

Specifically, the quinuclidine monomer may include quinuclidine-4-carboxaldehyde, quinuclidine-4-acetyl, quinuclidine-4-propionyl, quinuclidine-4-methoxycarbonyl, quinuclidine-4-benzoyl, quinuclidine-4-benzylcarbonyl, quinuclidine-4-ethoxycarbonyl, quinuclidine-4-trifluoroacetyl, quinuclidine-4-trifluoromethoxycarbonyl, quinuclidine-4-hexafluoroethoxycarbonyl, or derivatives thereof. In one embodiment, the quinuclidine monomer may include quinuclidine-4-trifluoroacetyl, but is not limited thereto.

The arylene compound may include any one selected from the compounds represented by the following structural formulas or derivatives thereof:

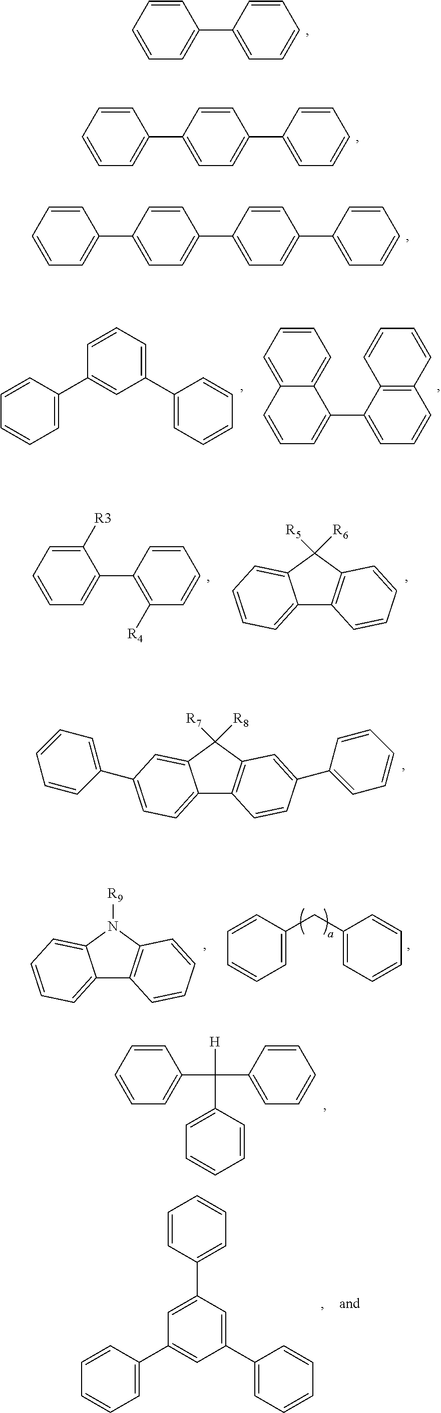

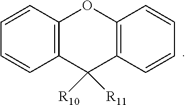

Here, R₃ to R₁₁ may each independently include hydrogen, a C1-C10 alkyl group, a C1-C10 aryl group, or a derivative thereof, and a may be an integer greater than or equal to 1.

The superacid catalyst has very strong acidity, and thus may be a compound used in polycondensation reactions to promote the formation and bonding of polymer chains. Specifically, this polymerization may be a Friedel-Crafts type polycondensation reaction, specifically a polyhydroxyalkylation reaction using an acetic acid catalyst.

Specifically, the superacid catalyst may include any one selected from trifluoromethanesulfonic acid (TFSA), fluorosulfonic acid (FSO₃H), pentafluoromethanesulfonic acid, methanesulfonic acid, and combinations thereof. In one embodiment, the superacid catalyst may include TFSA, but is not limited thereto.

The polymer synthesized by the polycondensation reaction may include a poly (arylene quinuclidine) polymer represented by Chemical Formula 8 below:

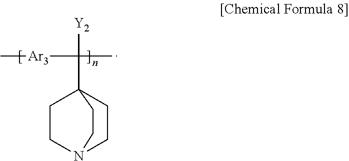

In Chemical Formula 8, Ar₃ may include an arylene compound, Y₂ may include hydrogen, a methyl group (—CH₃), an ethyl group (—C₂H₅), a methoxy group (—OCH₃), an ethoxy group (—OC₂H₅), a phenyl group (—C₆H₅), a benzyl group (—CH₂C₆H₃), a trifluoromethyl group (—CF₃), a trifluoromethoxy group (—OCF₃), a hexafluoroethoxy group (—OC₂F₆), or a derivative thereof, and n may be an integer greater than or equal to 1.

Next, after the polymerization is complete, a step (S03) of synthesizing a poly (arylene quinuclidinium) polymer by forming a quaternary ammonium salt via a Menshutkin reaction using the quinuclidin polymer and an alkyl halide may be carried out.

The Menshutkin reaction is a reaction in which a tertiary amine reacts with an alkyl halide (denoted as AX′) to form a quaternary ammonium salt. The reaction follows a nucleophilic substitution reaction (SN2 mechanism) and may refer to a reaction in which a nitrogen atom of the nucleophilic amine bonds to an alkyl group of the alkyl halide and eliminates a halogen atom. Specifically, when the Menshutkin reaction occurs in the quinuclidine dual ring structure, the nitrogen (N) atom of quinuclidine, a tertiary amine containing a lone pair of electrons, reacts with an alkyl halide, such as iodomethane (CH₃I or Mel), causing the nitrogen to acquire a positive charge and forming a quaternary ammonium compound. Quaternized quinuclidine may be denoted as quinuclidinium and may perform the role of anion transport in anion exchange polymers.

Anion exchange polymers including the poly (arylene quinuclidinium) polymer after the completion of the quaternization may include a polymer represented by Chemical Formula 9 below:

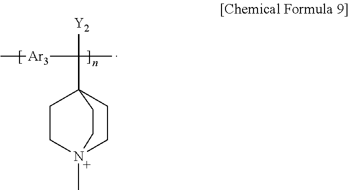

In Chemical Formula 9, Ar₃ may include an arylene compound, Y₂ may include hydrogen, a methyl group (—CH₃), an ethyl group (—C₂H₅), a methoxy group (—OCH₃), an ethoxy group (—OC₂H₅), a phenyl group (—C₆H₅), a benzyl group (—CH₂C₆H₅), a trifluoromethyl group (—CF₃), a trifluoromethoxy group (—OCF₃), a hexafluoroethoxy group (—OC₂F₆), or a derivative thereof, and n may be an integer greater than or equal to 1.

Hereinafter, the present invention will be explained in more detail using examples and comparative examples. However, the following examples and comparative examples are for illustrating the present invention, and the scope of the present invention is not limited thereto.

### Preparation Example 1: Synthesis of poly (arylene-4-(N-methyl-quinuclidinium) trifluoromethyl anion exchange polymer (4-X-qui)

Reaction schemes 4 to 6 below represent the synthesis steps of a poly (arylene-4-(N-methyl-quinuclidinium) trifluoromethyl-based anion exchange polymer according to one embodiment of the present invention.

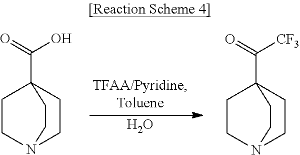 [SMILES: O=C(O)C12CCN(CC1)CC2 ; O ; O=C(C(F)(F)F)C12CCN(CC1)CC2]

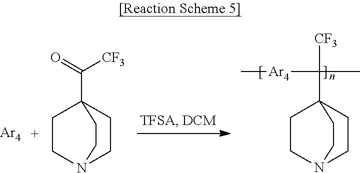

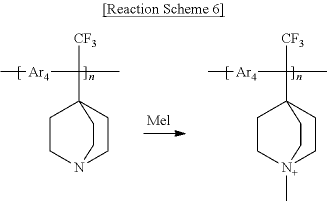

In Reaction Schemes 4 to 6, Ar₄ includes an arylene compound, and n is an integer greater than or equal to 1.

First, quinuclidine-4-carboxylic acid is dissolved in toluene and then allowed to react with trifluoroacetic anhydride (TFAA) to synthesize a quinuclidine-4-trifluoroacetate monomer through a reaction in which a carboxylic moiety is substituted with a trifluoroacetyl group. In this process, pyridine and water (H₂O) induce hydrolysis and decarboxylation of reactants.

Thereafter, the synthesized monomer and arylene compound are dissolved in dichloromethane (DCM) and allowed to react with trifluoromethanesulfonic acid (TFSA) to prepare a polymer through a Friedel-Crafts-type polycondensation reaction, specifically polyhydroxyalkylation using acetic acid as a catalyst.

After the polymerization is complete, the polymer is allowed to react with methyl iodide (MeI) to proceed with quaternization via a Menshutkin reaction. Finally, a poly (arylene quinuclidinium)-based anion exchange polymer is synthesized.

### Example 1: Anion Exchange Membrane (AEM) Including Poly (arylene-4-(N-methyl-quinuclidinium) trifluoromethyl (4-X-qui)

An AEM was manufactured using a poly (arylene-4-(N-methyl-quinuclidinium) trifluoromethyl anion exchange polymer (4-X-qui) prepared in Preparation Example 1 and represented by Chemical Formula 10 below:

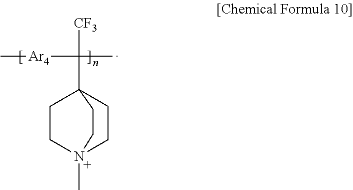

In Chemical Formula 10, Ar₄ includes an arylene compound, and n is an integer greater than or equal to 1.

### Comparative Example 1: AEM including poly (arylene-1-(N-quinuclidinium) trifluoromethyl (1-X-qui)

An AEM was manufactured using a poly (arylene-1-(N-quinuclidinium) trifluoromethyl anion exchange polymer (1-X-qui) represented by Chemical Formula 11 below:

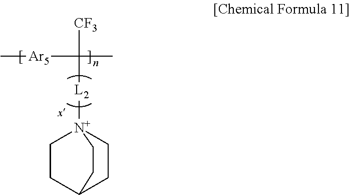

In Chemical Formula 11, Ar₅ includes an arylene compound, L₂ includes a C1-C10 alkyl group, a C1-C10 aryl group, a derivative thereof, or a combination thereof, n is an integer greater than or equal to 1, and x′ is an integer greater than or equal to 0.

When comparing the characteristics of the AEMs according to Example 1 and Comparative Example 1 of the present invention, in the case of the 1-X-qui structure (Comparative Example 1), the N atom of the quinuclidinium ring is directly connected to the polymer side chain, so β-hydrogens are present outside the quinuclidinium cage. The β-hydrogens positioned outside may be placed in vulnerable positions that may be easily attacked by OH ions. As a result, the 1-X-qui structure (Comparative Example 1) is highly likely to decompose in a basic environment. On the other hand, in the case of the 4-X-qui structure (Example 1), since β-hydrogens are present only inside the quinuclidinium cage, not all β-hydrogens form an anti-periplanar conformation with the nitrogen atom, making the structure relatively stable even in a basic environment. Therefore, the 4-X-qui structure (Example 1) provides much better stability in a basic environment compared to the 1-X-qui (Comparative Example 1), and can provide a structure suitable for various applications requiring high-temperature and basic conditions.

### Comparative Example 2: AEM including polyarylene-3-(N-methyl-quinuclidinium)

An AEM was manufactured using a polyarylene-3-(N-methyl-quinuclidinium) anion exchange polymer represented by Chemical Formula 12 below:

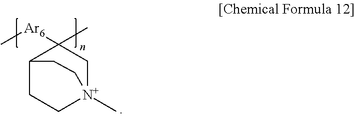

In Chemical Formula 12, Ar₆ is an arylene compound, and n is an integer greater than or equal to 1.

When comparing the characteristics of the AEMs according to Example 1 and Comparative Example 2 of the present invention, in the case of Comparative Example 2, the alkali stability of the polymer may be reduced because the quinuclidinium ring is directly connected to an aromatic ring of the polymer main chain due to structural characteristics, which are highly likely to induce distortion of the bicyclic ring. On the other hand, the 4-X-qui structure (Example 1) has structural characteristics in which the structure is not directly connected to a phenyl ring of the polymer main chain and almost no distortion caused by the spacer occurs. Therefore, the 4-X-qui structure (Example 1) can improve alkali stability compared to Comparative Example 2.

### Comparative Example 3: AEM including poly (arylene-4-(N,N-dimethylpiperidinium) trifluoromethyl

An AEM was manufactured using a poly (arylene-4-(N,N-dimethylpiperidinium) trifluoromethyl anion exchange polymer represented by Chemical Formula 13 below:

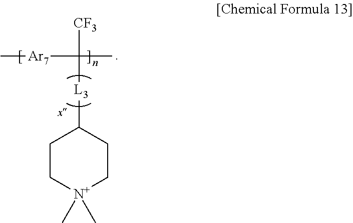

In Chemical Formula 13, Ar₇ includes an arylene compound, L₃ includes a C1-C10 alkyl group, a C1-C10 aryl group, a derivative thereof, or a combination thereof, n is an integer greater than or equal to 1, and x″ is an integer greater than or equal to 0.

When comparing the characteristics of the AEMs according to Example 1 and Comparative Example 3 of the present invention, Comparative Example 3 includes a piperidinium ring structure in the polymer side chain, and such a piperidinium-based structure undergoes continuous flipping between boat-chair conformations in terms of chemical structure. During this process, when the chair structure is formed, the nitrogen atom is positioned at an anti-periplanar position with the axially positioned B-hydrogen, which may lead to Hofmann elimination (E2 elimination) reactions. Consequently, the piperidinium ring is easily decomposed in a basic environment, resulting in reduced chemical stability. On the other hand, the 4-X-qui structure (Example 1) is resistant to Hofmann elimination reactions due to the structural characteristics such that the formation of an anti-periplanar conformation caused by a quinuclidine-based bicyclic cage does not occur, and thus the structure can have higher chemical stability even in a basic environment.

Comparative Example 4: AEM including polyarylene-4-(N,N-dimethylpiperidinium)

An AEM was manufactued using a polyarylene-4-(N,N-dimethylpiperidinium) anion exchange polymer represented by Chemical formula 14 below:

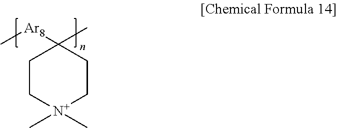

In Chemical Formula 12, Ar₇ is an arylene compound, and n is an integer greater than or equal to 1.

When comparing the characteristics of the AEMs according to Example 1 and Comparative Example 4 of the present invention, in the case of Comparative Example 4, structural instability increases due to distortion of the six-membered cyclic structure caused by the structural characteristics in which the carbon within the piperidinium ring is directly connected to the polymer main chain. On the other hand, in the case of the 4-X-qui structure (Example 1), the structure is not directly connected to a phenyl ring of the polymer main chain, and also the structure has structural characteristics in which the Hofmann elimination reaction may not occur due to the inherent bicyclic cage shape.

Although embodiments of the present invention have been described above with reference to the attached drawings, those skilled in the art will understand that the present invention may be implemented in other specific forms without changing its technical concept or essential features. Therefore, the above-described embodiments should be understood as illustrative in all respects and not restrictive.

1. An anion exchange polymer comprising:
a 4-X-quinuclidinium structure represented by Chemical Formula 1 below, wherein carbon corresponding to position 4 of a quinuclidinium ring is connected to a polymer main chain (X): 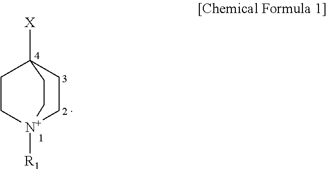
wherein in Chemical Formula 1, X includes a repeating unit represented by Chemical Formula 2 below or an arylene compound, and R₁ is hydrogen, a C1-C20 alkyl group, a C1-C20 aryl group, or a derivative thereof: 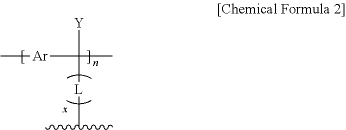
wherein in Chemical Formula 2, Ar includes an arylene compound, Y includes hydrogen, a methyl group (—CH₃), an ethyl group (—C₂H₅), a methoxy group (—OCH₃), an ethoxy group (—OC₂H₅), a phenyl group (—C₆H₅), a benzyl group (—CH₂C₆H₅), a trifluoromethyl group (—CF₃), a trifluoromethoxy group (—OCF₃), a hexafluoroethoxy group (—OC₂F₆), or a derivative thereof, L includes a C1-C10 alkyl group, a C1-C10 aryl group, a derivative thereof or a combination thereof, n is an integer greater than or equal to 1, and x is an integer greater than or equal to 0.

2. The anion exchange polymer according to claim 1, wherein the anion exchange polymer is an anion exchange polymer including a repeating unit represented by Chemical Formula 3 below: 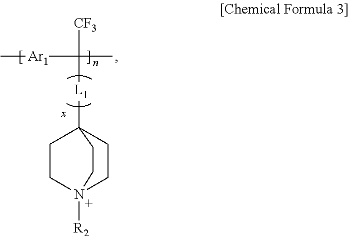
wherein in Chemical Formula 3, Ar₁ includes an arylene compound, L₁ includes a C1-C10 alkyl group, a C1-C10 aryl group, a derivative thereof, or a combination thereof, R₂ is hydrogen, a C1-C10 alkyl group, a C1-C10 alkoxy group, a C1-C10 aryl group, or a derivative thereof, n is an integer greater than or equal to 1, and x is an integer greater than or equal to 0.

3. The anion exchange polymer according to claim 1, wherein the anion exchange polymer is an anion exchange polymer including a repeating unit represented by Chemical Formula 4 below: 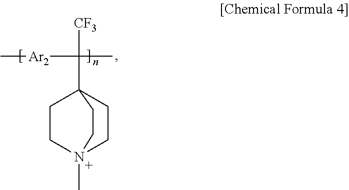
wherein in Chemical Formula 4, Ar₂ includes an arylene compound, and n is an integer greater than or equal to 1.

4. The anion exchange polymer according to claim 1, wherein the anion exchange polymer includes a poly (arylene-4-(N-methyl-quinuclidinium) trifluoromethyl) repeating structure.

5. The anion exchange polymer according to claim 1, wherein the anion exchange polymer includes β-hydrogen that does not form an anti-periplanar conformation inside a quinuclidinium cage.

6. An anion exchange membrane comprising the anion exchange polymer according to claim 1.

7. A membrane-electrode assembly comprising the anion exchange membrane according to claim 6.

8. A water electrolysis system comprising the anion exchange membrane according to claim 6.

9. A method of preparing an anion exchange polymer, comprising:
a step S01 of synthesizing a quinuclidine monomer by allowing a quinuclidine precursor, an organic acid, a catalyst, and a solvent to react;
a step S02 of synthesizing a poly (arylene quinuclidine) polymer by polycondensation reaction using the quinuclidine monomer, an arylene compound, and a superacid catalyst after Step S01; and
a step S03 of synthesizing a poly (arylene quinuclidinium) polymer by forming a quaternary ammonium salt via a Menshutkin reaction using the quinuclidine polymer and an alkyl halide after Step S02.
